(19) United States
(12) Patent Application Publication
(10) Pub. No.: US 2012/0015099 A1
(43) Pub. Date: Jan. 19, 2012

(54) STRUCTURE AND METHOD FOR FABRICATING A MAGNETIC THIN FILM MEMORY HAVING A HIGH FIELD ANISOTROPY

(75) Inventors: Jijun SUN, Chandler, AZ (US); Jon SLAUGHTER, Tempe, AZ (US); Nicholas RIZZO, Gilbert, AZ (US)

(73) Assignee: EVERSPIN TECHNOLOGIES, INC., Chandler, AZ (US)

(21) Appl. No.: 12/837,307

(22) Filed: Jul. 15, 2010

(51) Int. Cl. B05D 5/00

(52) U.S. Cl. 427/129; 427/131

(57) ABSTRACT

A method for depositing uniform and smooth ferromagnetic thin films with high deposition-induced microstructural anisotropy includes a magnetic material deposited in two or more static oblique deposition steps from opposed directions to form a free layer having a high kink Hk, a high energy barrier to thermal reversal, a low critical current in spin-torque switching embodiments, and improved resistance to diffusion of material from adjacent layers in the device. Nonmagnetic layers deposited by the static oblique deposition technique may be used as seed layers for a ferromagnetic free layer or to generate other types of anisotropy determined by the deposition-induced microstructural anisotropy. Additional magnetic or non-magnetic layers may be deposited by conventional methods adjacent to oblique layer to provide magnetic coupling control, reduction of surface roughness, and barriers to diffusion from additional adjacent layers in the device.

### TECHNICAL FIELD

The exemplary embodiments described herein generally relates to semiconductor memory devices and more particularly to memory devices using magnetic thin films.

### BACKGROUND

Magnetoelectronic devices are used in numerous information devices, and provide non-volatile, reliable, radiation resistant, and high-density data storage and retrieval. The numerous magnetoelectronics information devices include, but are not limited to, Magnetoresistive Random Access Memory (MRAM), magnetic sensors, and read/write heads for disk drives.

For an MRAM device, the stability of the memory state, the repeatability of the read/write cycles, and the power consumption are some of the more important aspects of its design characteristics. A memory state in MRAM is not maintained by power, but rather by the direction of a magnetic moment vector. In typical MRAM devices, storing data is accomplished by applying magnetic fields and causing a magnetic material in an MRAM cell to be magnetized into either of two possible memory states. Recalling data is accomplished by sensing the resistive state of the cell which depends on the magnetic state. The magnetic fields are created by passing currents through strip lines external to the magnetic structure

For MRAM devices, the switching field H_{sw} is proportional to the total anisotropy H_{K-total} of the bit, which can include contributions from the device shape and material composition. Most MRAM devices rely on a bit shape having an aspect ratio greater than unity to create a shape anisotropy H_{K-shape} that provides the switching field H_{sw}.

However, there are several drawbacks to relying on H_{K-shape} to provide H_{sw}. First, H_{K-shape} increases as the bit dimension shrinks so that H_{sw} increases for a given shape and film thickness. A bit with larger H_{sw} requires more current to switch in field switched MRAM devices. Second, variations in H_{sw} will occur due to variations in bit shape from lithographic patterning and etching. These variations will increase as the bit size shrinks due to the finite resolution of optical lithography and etch processes. Variations in H_{sw} translate into a smaller operating window for programming of the bits using a magnetic field and are therefore undesirable. Third, the range over which the magnitude of H_{K-shape} can be varied is limited. Only certain bit shapes produce reliable switching and although varying the thickness of the film will vary H_{K-shape}, there is a maximum bit thickness above which the bit switching quality degrades due to domain formation.

Other MRAM devices rely on anisotropy from pair ordering of like atoms to provide all or part of the total anisotropy field H_{K-total}. For example, if a nickel iron (NiFe) film is deposited in a magnetic field, a small percentage of the iron (Fe) and nickel (Ni) atoms pair with like atoms and form chains parallel to the magnetic field, providing a pair anisotropy of approximately 5.0 Oe substantially parallel to the magnetic field direction.

Pair ordering anisotropy H_{K-pair} has the advantage of being substantially independent of bit shape and is relatively unchanged as the bit size decreases. However, the magnitude and direction of H_{K-pair} can drift with temperature. This temperature drift substantially results from thermal diffusion of the atom pairs. In addition, the magnitude of H_{K-pair} is predominately fixed for a particular magnetic material which limits the range of H_{sw}.

It has been observed that a strong anisotropy can be induced into a thin film by a film-growth process in which the depositing atoms are incident upon the growth surface at an oblique angle far from the normal to the film plane. Such an oblique deposition can, under the right conditions, produce an asymmetry in the microstructure of the film that results in a strong uniaxial anisotropy. However, the oblique deposition also results in a large nonuniformity of the film thickness over the surface, a higher micro-roughness of the film surface, degraded soft-magnetic properties, and an increased propensity for in-diffusion of atoms from adjacent materials, as compared to films deposited with an average angle of incidence close to the surface normal direction.

Non-uniform films and rough films are undesirable because they reduce manufacturing process margin, production yield, and device performance. In MRAM and other devices using magnetic material, magnetic film uniformity is very crucial for their device performance. For example, a non-uniform magnetic film causes bit-to-bit, or circuit-to-circuit, variation of magnetic characteristics such as switching field (H_{sw}). This variation leads to a reduction of manufacturing process margin and hence production yield. It is very difficult to form a high quality dielectric tunneling barrier on a film with a rough surface. This rough surface usually causes large bit-to-bit resistance variation and can increase interlayer diffusion which reduces device reliability.

Accordingly, it is desirable to provide a new and improved method of fabricating a magnetoresistive random access memory device having a uniform thin film thickness with a smooth surface, and a low spin-torque switching current and a high energy barrier to magnetization reversal caused by thermal fluctuations. Furthermore, other desirable features and characteristics of the exemplary embodiments will become apparent from the subsequent detailed description and the appended claims, taken in conjunction with the accompanying drawings and the foregoing technical field and background.

### BRIEF SUMMARY

A thin-film magnetic device having a high H_{K} magnetic material, a high energy barrier to thermal reversal, a low critical current in spin-torque embodiments, improved roughness, cross-wafer uniformity, and resistance to diffusion from an adjacent metal layer is provided.

An exemplary method of fabricating a monolithically integrated device includes depositing a first layer from a first direction onto a surface of a material and at a first non-zero deposition angle from a normal to the surface, and forming a second layer from a second direction over the first layer and at a second non-zero deposition angle from the normal to the surface.

Another exemplary method of fabricating a monolithically integrated device includes providing a substrate; providing an insulating material having a surface forming a plane; depositing a first magnetic layer over the surface from a direction and at a non-zero angle to perpendicular to the surface; rotating by 180 degrees the substrate and the first magnetic layer deposited thereon; and depositing a second magnetic layer onto the first magnetic layer from the same direction and at the non-zero angle to perpendicular to the surface.

Yet another exemplary method of fabricating a monolithically integrated device includes providing an insulating material having a surface forming a plane; depositing a first ferromagnetic layer onto the surface from a first direction and at a non-zero angle to perpendicular to the surface; and depositing a second ferromagnetic layer onto the first magnetic layer from a second direction and at the same angle to perpendicular to the surface, the second direction being opposed to the first direction.

### BRIEF DESCRIPTION OF THE DRAWINGS

The present invention will hereinafter be described in conjunction with the following drawing figures, wherein like numerals denote like elements, and

FIG. 1 is a sectional view of a conventional magnetoresistive random access memory device;

FIG. 2 is a simplified plan view of the magnetoresistive random access memory device of FIG. 1;

FIG. 3 is a cross section of a conventional spin torque transfer memory element;

FIGS. 4 and 5 are partial cross sections of a structure having two layer obliquely deposited on a substrate in accordance with an exemplary embodiment;

FIG. 6 is a substrate having eight layers obliquely deposited on the substrate in accordance with an exemplary embodiment;

FIG. 7 is an oblique view of a substrate with a material layer being deposited at a nonzero deposition angle;

FIG. 8 is a graph illustrating a magnitude of an induced anisotropy verses a deposition angle for a 2.5 nm cobalt iron boron (CoFeB) layer;

FIG. 9 is a graph of film uniformity (sigma %) versus the number of oblique deposition steps;

FIG. 10 is a graph of the anisotropy field H_{K} versus the number of oblique deposition steps;

FIG. 11-17 are partial cross sections of various MRAM free layers fabricated in accordance with exemplary embodiments; and

FIG. 18 is a flow chart of the steps in fabricating in accordance with the exemplary embodiments.

### DETAILED DESCRIPTION

The following detailed description is merely illustrative in nature and is not intended to limit the embodiments of the subject matter or the application and uses of such embodiments. Any implementation described herein as exemplary is not necessarily to be construed as preferred or advantageous over other implementations. Furthermore, there is no intention to be bound by any expressed or implied theory presented in the preceding technical field, background, brief summary, or the following detailed description.

The embodiments described herein include a new MRAM structure, and method of manufacture of the structure, having a magnetic free layer deposited in two or more static oblique deposition steps from opposed directions. For example, a first oblique deposition may be performed, the structure rotated 180 degrees, and a second oblique deposition is performed. Various exemplary embodiments include optional smooth magnetic and/or non-magnetic layers that prevent diffusion of an oxide to metal conductor layers. A magnetic device is provided having a high H_{K} magnetic material, a high energy barrier, a low switching current in spin-torque embodiments, and reduced diffusion to an adjacent metal layer.

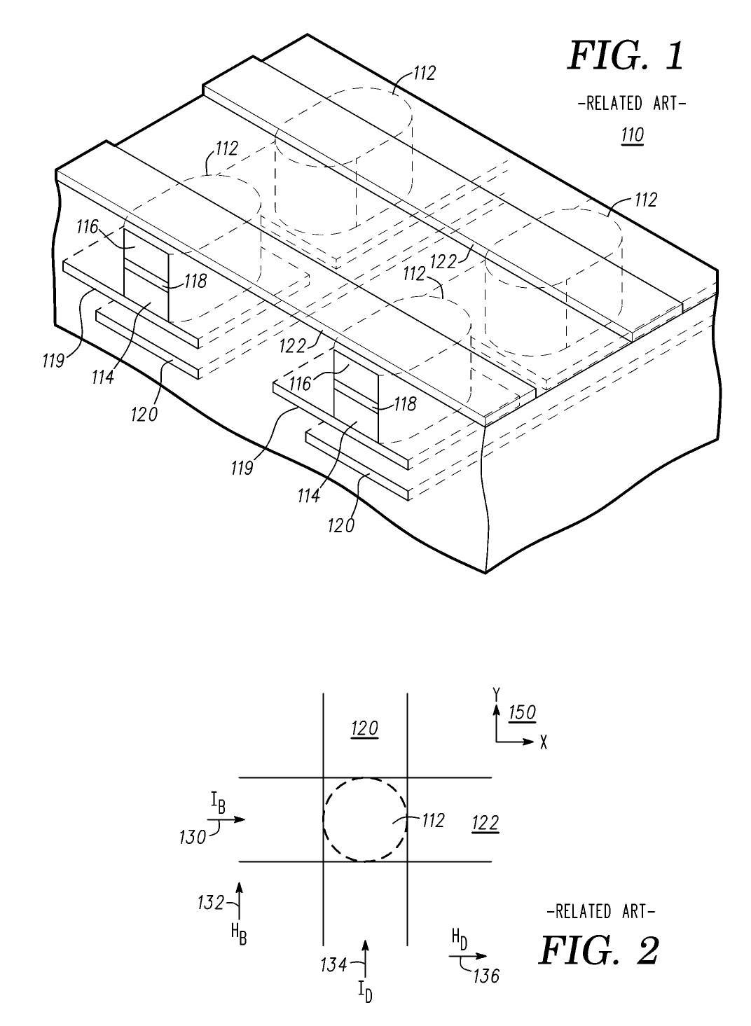

MRAM technology uses magnetic components to achieve non-volatility, high-speed operation, and excellent read/write endurance. The concepts presented herein may be applied to either a conventional memory or a spin torque MRAM (ST-MRAM). FIG. 1 illustrates a conventional memory element array 110 having one or more memory elements 112. An example of one type of magnetic memory element, a magnetic tunnel junction (MTJ) element, comprises a fixed ferromagnetic layer 114 that has a magnetization direction fixed with respect to an external magnetic field and a free ferromagnetic layer 116 that has a magnetization direction that is free to rotate with the external magnetic field. The fixed layer and free layer are separated by an insulating tunnel barrier layer 118. The resistance of memory element 112 relies upon the phenomenon of spin-polarized electron tunneling through the tunnel barrier layer between the free and fixed ferromagnetic layers. The tunneling phenomenon is electron spin dependent, making the electrical response of the MTJ element a function of the relative magnetization orientations and spin polarization of the conduction electrons between the free and fixed ferromagnetic layer.

The memory element array 110 includes conductors 120, also referred to as digit lines 120, extending along rows of memory elements 112, conductors 122, also referred to as word or bit lines 122, extending along columns of the memory elements 112, and conductor 119, also referred to as an electrode 119, electrically contacting the fixed layer 114. While the electrodes 119 contact the fixed ferromagnetic layer 114, the digit line 120 is spaced from the electrodes 119 by, for example, a dielectric material (not shown). A memory element 112 is located at a cross point of a digit line 120 and a bit line 122. The magnetization direction of the free layer 116 of a memory element 112 is switched by supplying currents to digit line 120 and bit line 122. When applied currents are large enough, the currents create magnetic fields that switch the magnetization orientation of the selected memory element from parallel to anti-parallel, or vice versa. To sense the resistance of element 112 during the read operation, a current is passed from a transistor in the substrate (not shown) through a conductive via (not shown) connected to electrode 119.

MRAM device 110 has tri-layer structures 112 that have a length/width ratio in a range of one to five for a non-circular plan. A plan with an aspect ratio equal to one is illustrated in FIG. 2. MRAM element 112 is elliptical in shape in the preferred embodiment to minimize the contribution to switching field variations from shape anisotropy and also because it is easier to use photolithographic processing to scale the device to smaller dimensions laterally. However, it will be understood that MRAM device 110 can have other shapes, such as circular, square, rectangular, diamond, or the like, but is illustrated as being elliptical for simplicity and improved performance.

FIG. 2 illustrates the fields generated by a conventional linear digit line 120 and bit line 122. To simplify the description of MRAM device 110, all directions will be referenced to an x- and y-coordinate system 150 as shown. A bit current I_{B} 130 is defined as being positive if flowing in a positive x-direction and a digit current I_{D} 134 is defined as being positive if flowing in a positive y-direction. A positive bit current I_{B} 130 passing through bit line 122 results in a circumferential bit magnetic field, H_{B} 132, and a positive digit current ID 134 will induce a circumferential digit magnetic field H_{D} 136. The magnetic fields H_{B} 132 and H_{D} 136 combine to switch the magnetic orientation of the memory element 112.

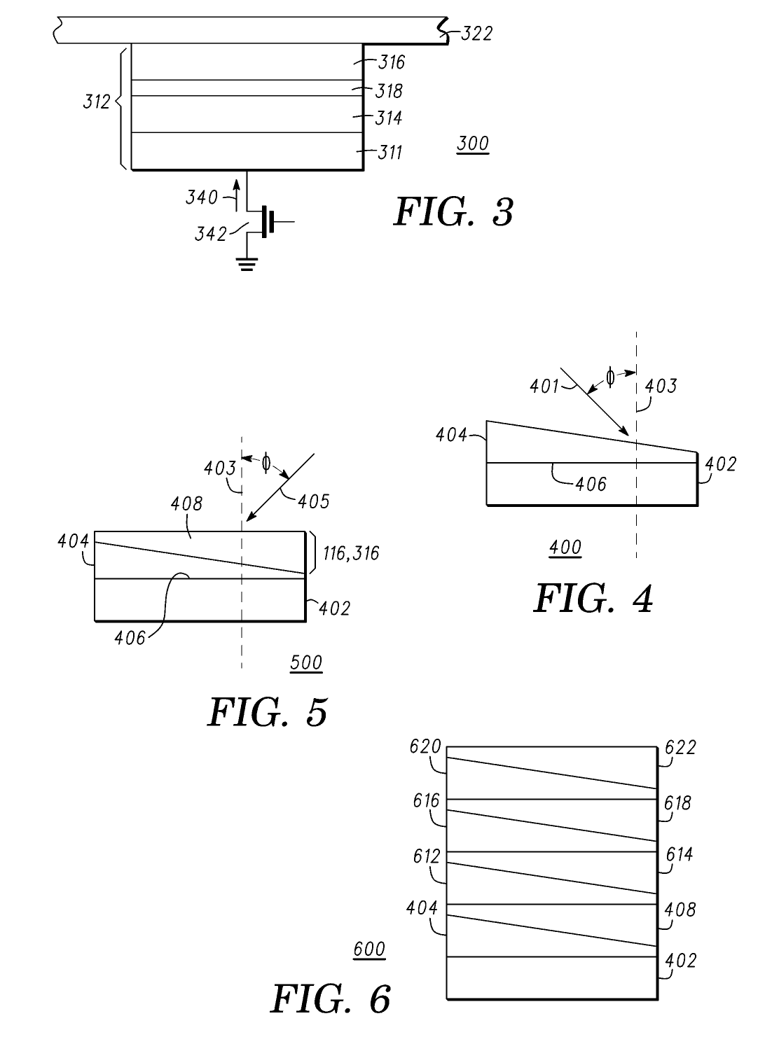

In spin-torque MRAM (ST-MRAM) devices, such as the simplified sectional view of the structure 300 shown in FIG. 3, the bits are written by forcing a current 340 directly through the stack of materials that make up the magnetic tunnel junction 312, e.g., via current passing from isolation transistor 342 to conductor 322. Generally speaking, the write current 340 which is spin polarized by passing through one ferromagnetic layer (314 or 316), exerts a spin torque on the subsequent layer after passing through a tunnel barrier layer 318. This torque can be used to switch the magnetization of free magnet 316 between two stable states by changing the write current polarity. In MTJ 312, the state of the pinned layer 314 is set by pinning layer 311 during MTJ deposition or post-anneal process.

In this illustration, only a single magnetoresistive memory element 300 is shown for simplicity in describing the embodiments of the present invention, but it will be understood an MRAM array may include a number of magnetoresistive memory elements 100.

The magnetic tunnel junction 312 may include a SAF structure, for example, one or both of ferromagnetic layers 314 and 316 are made from a synthetic antiferromagnet (SAF) where two ferromagnetic layers are separated from and anti-ferromangetically coupled through a non-magnetic spacer, such as Ru, Rh, Re, or their alloys. Ferromagnetic portion 314 is on top of antiferromagnetic pinning layer 311, which holds the magnetization direction of layer 314 in a fixed direction. Antiferromagnetic pinning layer 311 may comprised materials such as PtMn, IrMn, FeMn, PdMn, or combinations thereof. However, it will be appreciated by those skilled in the art that magnetic tunnel junction 312 may have any structure suitable for providing a fixed magnetic portion in contact with the tunnel barrier to provide a fixed magnetic reference direction.

Ferromagnetic portions 314 and 316 may be formed from any suitable magnetic material, such as at least one of the elements Ni, Fe, Co, or their alloys that may also include nonmagnetic materials such as B, Cu, Mo, Ta, Ti, V, or from so-called half-metallic ferromagnets such as NiMnSb, PtMnSb, Fe₃O₄, or CrO₂. The tunnel barrier 318 may be insulator materials such as AlOx, MgOx, HfOx, ZrOx, TiOx, or the nitrides and oxidinitrides of these elements. It is further understood that the tunnel barrier 318 could be a conductive nonmagnetic spacer layer such that the device exhibits the giant magnetoresistance effect (GMR) or other types of spacer layers that exhibit related magnetoresistance effects rather than the tunneling magnetoresistance effect (TMR); however, the device otherwise operates in the same manner as if an insulating tunnel barrier material were used for layer 318.

During fabrication of an MRAM array including a plurality of bits, each succeeding layer is deposited or otherwise formed in sequence and each magnetic tunnel junction 312 may be defined by selective deposition, photolithography processing, etching, etc. using any of the techniques known in the semiconductor industry. A magnetic field is typically provided during deposition of at least the ferromagnetic portions 314 and 316, and/or during a subsequent anneal at elevated temperature, to set a preferred intrinsic anisotropy direction (intrinsic anisotropy). A portion of MRAM device 300 is deposited at a nonzero deposition angle θ, as will be discussed hereinafter.

MRAM device 300 is capable of flowing a tunneling current through tunneling barrier 318. The tunneling current substantially depends on a tunneling magnetoresistance of MRAM device 300, which is governed by the relative orientation of magnetic moment vectors adjacent to tunneling barrier 318. If the magnetic moment vectors are substantially parallel, then MRAM device 300 has a low resistance and a voltage bias between conductive line 322 and transistor 342 will create a larger tunneling current through MRAM device 300. This state is defined as a “1”.

If the magnetic moment vectors are substantially anti-parallel, then MRAM device 300 will have a high resistance and an applied voltage bias between conductive line 322 and transistor 342 will create a smaller current through MRAM device 300. This state is defined as a “0”.

It will be understood, however, that these definitions are arbitrary and could be reversed, but are used in this example for illustrative purposes. Thus, in typical magnetoresistive memory, data storage is accomplished by applying magnetic fields that cause the magnetic moment vectors in the free ferromagnetic region to be orientated in either one of parallel and anti-parallel directions relative to the magnetic moment vector in the pinned ferromagnetic region.

Further, during fabrication of an MRAM array comprising either of magnetic memories 110, 300, each succeeding layer is deposited or otherwise formed in sequence and each MRAM device 110, 300 may be defined by selective deposition, photolithography processing, etching, etc. in any of the techniques well known to those skilled in the art.

In accordance with the exemplary embodiments, the free layer 116, 316 of FIGS. 1 and 3, respectively, may be fabricated as follows. Referring to FIGS. 4 and 5, a structure 500 has a ferromagnetic layer 404 formed on a surface 406 of a spacer layer 402. The magnetic layer 404 is obliquely vapor deposited at a first direction (represented by the arrow 401) forming an angle Φ to the normal line 403 perpendicular to the surface 406. A magnetic layer 408 is then obliquely vapor deposited at a second direction (represented by the line 405) also forming an angle Φ to the normal line 403, but in an opposite direction towards the surface 406, to form the free layer 116, 316. This second oblique deposition to form the magnetic layer 408 may be accomplished by rotating the work piece or substrate 180 degrees and repeating the oblique deposition as was accomplished to form the magnetic layer 404. Any number of magnetic layers 404, 408 may be formed. For example, a structure 600 is shown in FIG. 6 having eight magnetic layers 404, 408, 612, 614, 616, 618, 620, 622 formed on the spacer layer 402 by rotating the work piece or substrate, thus rotating the structure 600 after each layer 404, 408, 612, 614, 616, 618, 620, 622 has been deposited and before depositing the next layer.

While the above described embodiment is a free layer 316 formed on a spacer layer 318 of an MRAM device, it should be understood that the layers 404, 408 may comprise any material, e.g., dielectric, conductive, magnetic, or nonmagnetic and may be formed on any base material including a substrate or an insulating layer, for example.

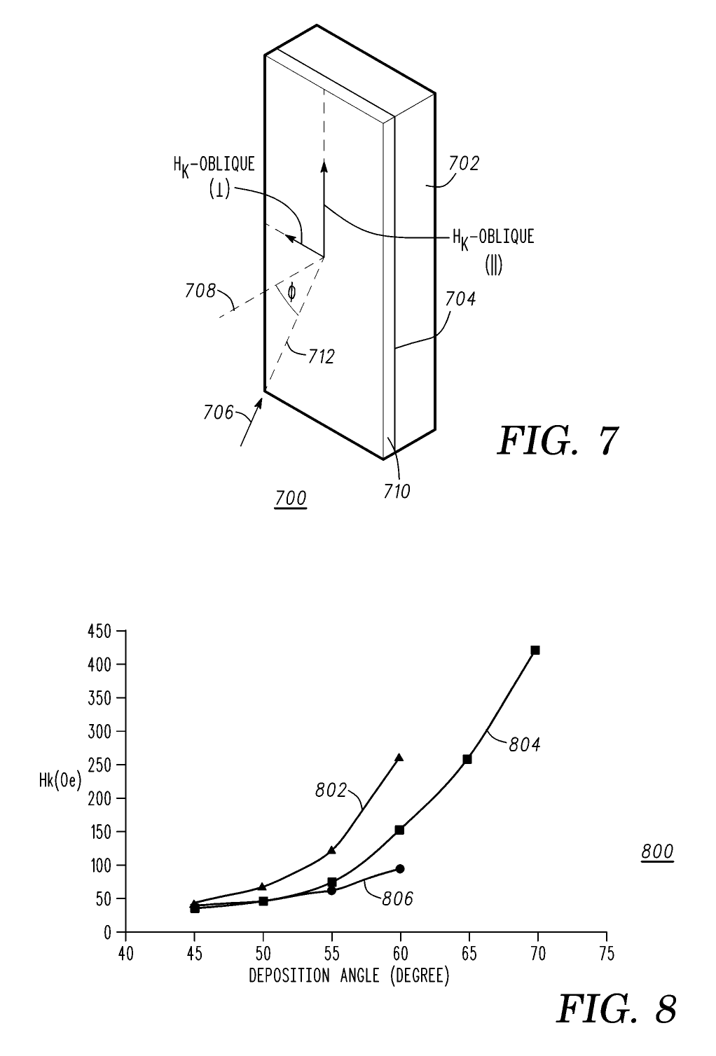

As mentioned previously, layer 116 of MRAM device 110 and layer 316 of ST-MRAM device 300 are deposited at the nonzero deposition angle Φ, as will be shown in FIG. 7 where a substrate 702 with a surface 704 is illustrated. A material flux 706 is incident to surface 704 at the angle Φ relative to a reference line 708 oriented perpendicular to surface 704. Material flux 706 forms a material region 710 positioned on surface 704. Layer 710 typically has an induced uniaxial magnetic anisotropy, H_{K-oblique}, substantially oriented parallel, H_{K-oblique} (∥), or perpendicular, H_{K-oblique} (⊥), to a plane of incidence and parallel to surface 704. The plane of incidence is defined by reference line 708 and a reference line 712 oriented parallel to material flux 706. Further, it will be understood that material flux 706 can include magnetic or non-magnetic materials. In the preferred embodiment, the direction of the induced magnetic anisotropy of material region 710 substantially depends on Φ.

Atoms deposited by vapor deposition techniques such as evaporation, physical vapor deposition, or ion-beam deposition have a distribution of deposition angles that is dependent on the details of the deposition process. The deposition angle Φ is defined as the average deposition angle for the flux of atoms that deposit on the wafer to form the layer. To achieve an average angle of zero, the atoms can be directly deposited at normal incidence or the flux of atoms can have deposition angle Φ while the substrate or work piece is rotated continuously to form films with high uniformity and no deposition-induced anisotropy.

It will be understood that the free layers 116, 316 can be deposited using an ion beam deposition system, a physical vapor deposition system, or the like, wherein, in the preferred embodiment, a portion of the free layers 116, 316 deposited at a nonzero deposition angle is performed with the substrate static (non-rotating during deposition), and then another portion is deposited at a nonzero deposition angle with the substrate static (non-rotating during deposition). To produce a large induced H_{K-oblique} it is desirable to produce a relatively collimated beam of incident flux material. A collimated beam can usually be produced within low pressure deposition systems or systems that have long target to substrate distances.

Referring to FIG. 8 which illustrates a graph 800 of the magnitude of the induced magnetic anisotropy, H_{K}, verses deposition angle Φ. The line 802 represents two oblique depositions from opposite directions for a material comprising CoFeB. The line 804 represents two oblique depositions from opposite directions for a material comprising CoFeB and two oblique depositions from opposite directions for a material comprising Fe prior to CoFeB deposition. The line 806 represents two oblique depositions from opposite directions for a material comprising CoFeB and a standard rotating deposition for a material comprising Fe prior to CoFeB deposition. It may be seen that anisotropy field H_{K} increases as deposition angle Φ, for deposition angles greater than 45 degrees, indicating a large contribution from the induced anisotropy H_{K-oblique} that is increasing with increasing deposition angle Φ. For the CoFeB alloy, a perpendicular H_{K} is observed as shown in FIG. 8. It has been found that the anisotropy field strength and direction are strongly dependent on the composition of magnetic alloys, underlayer, overlayer, and deposition angle. High H_{K} leads to a high energy barrier of MRAM bits resulting in better data retention.

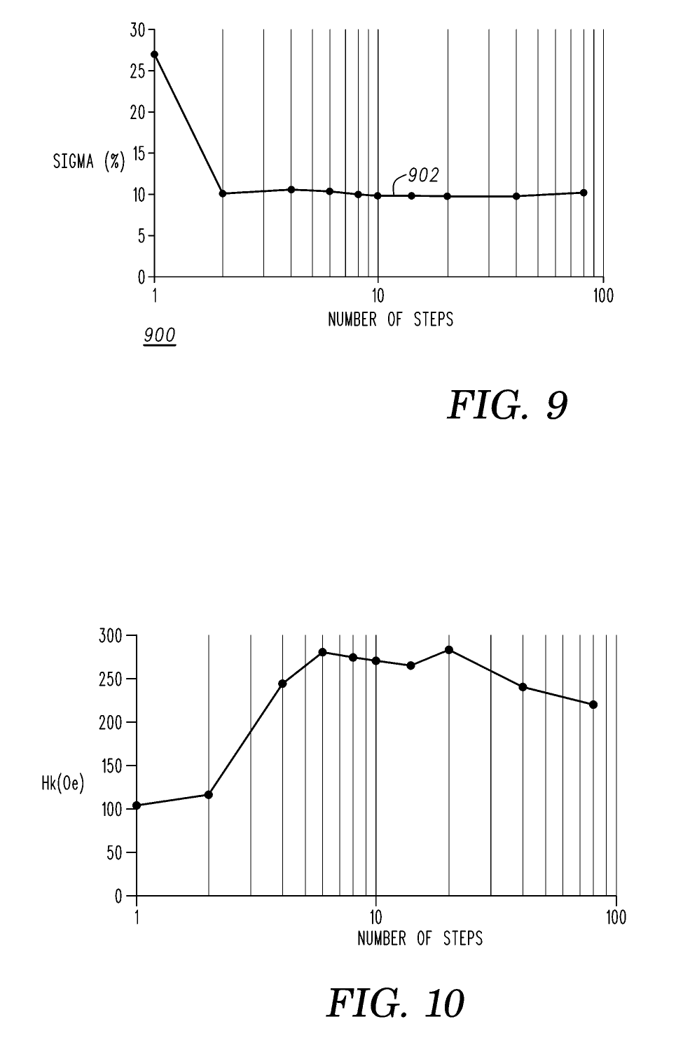

FIG. 9 illustrates a graph 900 of the standard deviation of the sheet resistance (sigma) versus the number of deposition steps for a deposition angle of 60 degrees (e.g., two steps as shown in FIG. 5 and eight steps as shown in FIG. 6). It may be seen that a two-step process substantially improves to a value of sigma (line 902) to 10% from 27% obtained with the previously known one-step process. It is also seen that sigma essentially remains at 10% for any number of steps equal to or greater than two.

FIG. 10 shows H_{K} versus the number of deposition steps used to deposit a 20 nm thick CoFeB film. While a two-step oblique deposition process is improved over one oblique deposition, four or six is much better for this film thickness, reaching an H_{K} of about 280 Oe for the six-step process.

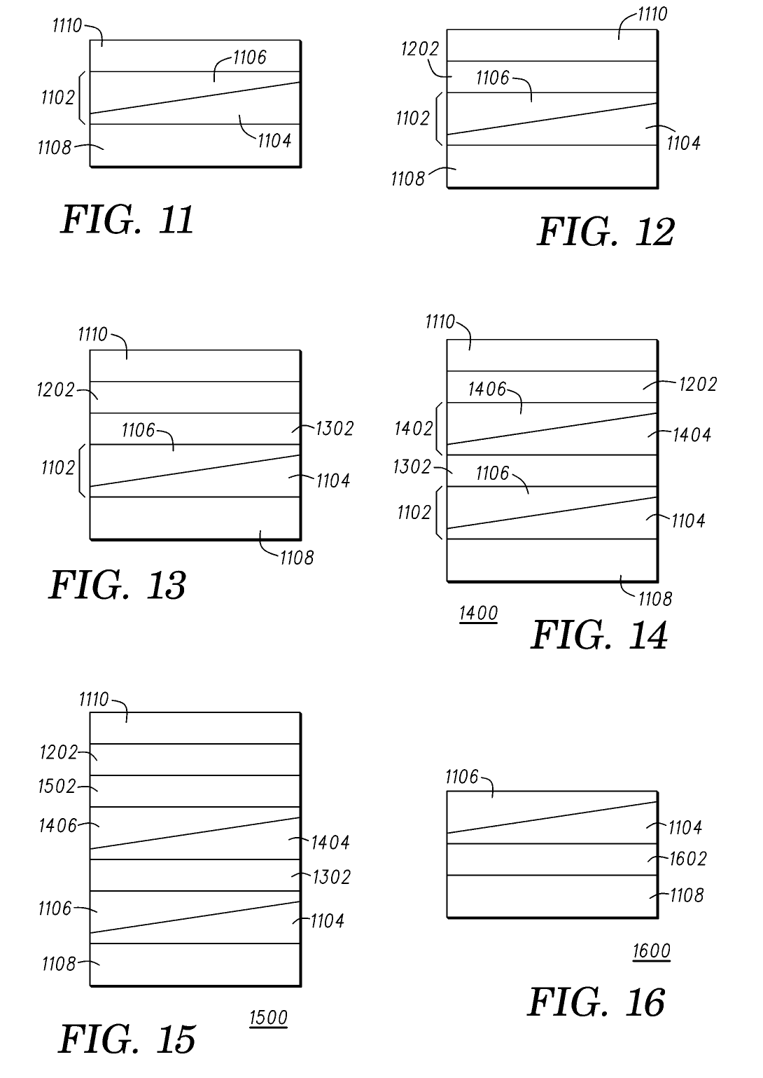

Referring back to FIG. 3, it will be understood that there are several other memory devices like that of memory device 300 that include at least two layers deposited at a nonzero deposition angle Φ. The free layer 1102 of FIG. 11 includes two layers 1104, 1106 each of which is formed at a non-zero deposition angle from opposed directions on the spacer layer 1108. A cap layer 1110 is deposited on the layer 1106. In a bottom-pinned MTJ, spacer layer 1108 will be a tunnel barrier separating the pinned layer from the free layer 1102, and cap layer 1110 will be a top electrode layer and may include a diffusion barrier layer between the free layer 1102 and the cap layer 1110. Cap layer 1110 is typically deposited with the wafer rotated to ensure good thickness uniformity and smoothness. In a top-pinned MTJ, spacer layer 1108 will be a bottom electrode that makes electrical contact to the MTJ and seeds the growth of the free layer 1102, and cap layer 1110 will be the tunnel barrier separating the free layer from the pined layer above. The layers 1104, 1106 are preferably a material comprising one of Co, Fe, CoFe, and CoFeB for both layers 1104, 1106. The spacer layer 1108 and the diffusion barrier are preferably a material comprising MgO. The cap layer 1110 provides a low resistance compared to spacer layer 1108, but impedes diffusion to the metal contact layer 322 (see FIG. 3).

The free layer 1102, including layers 1104, 1106, of FIG. 12 is formed between the spacer layer 1108 and the cap layer 1110 as in FIG. 11; however, a magnetic layer 1202 is deposited on the layer 1106 prior to the deposition of the cap layer 1110. The magnetic layer 1202 may be formed from any suitable magnetic material, such as at least one of the elements Ni, Fe, Co, or their alloys that may also include nonmagnetic materials such as B, Cu, Mo, Ta, Ti, V, or from so-called half-metallic ferromagnets such as NiMnSb, PtMnSb, Fe₃O₄, or CrO2. Layer 1202 is also deposited with the wafer rotating so that it has uniform thickness and is smooth. Therefore the barrier will have improved integrity to prevent diffusion of atoms from metal contact layer 322 into the free layer. In one embodiment, magnetic layer 1202 preferably has a significantly lower magnetization than magnetic layer 1102, so that the free layer magnetization reversal is less affected by the magnetic properties of layer 1202.

Magnetic layer 1202 positioned on top of free layer 1102 is also beneficial for embodiments that include a top-pinned magnetic tunnel junction device. A top-pinned device has the fixed magnetic layer and tunnel barrier layer on top of the magnetic free layer, rather than below as described previously. Since obliquely deposited free layers without wafer rotation tend to be rougher, the tunnel barrier integrity can be compromised for a top-pinned device. Therefore, magnetic layer 1202 deposited with wafer rotation can provide a smoother surface on which the tunnel barrier will be deposited. Similar arguments apply for dual magnetic tunnel junction device that contains an obliquely deposited free layer. A dual tunnel junction device contains pinned layers and associated tunnel barrier layers both below and above free layer 1202.

Referring to FIG. 13, the free layer 1102 including layers 1104, 1106, magnetic layer 1202, and cap layer 1110 are formed over the spacer layer 1108 as in FIG. 12, except a non-magnetic layer 1302 is deposited in the standard way with wafer rotation (with an average zero deposition angle to perpendicular to the surface) onto the free layer 1102 prior to the deposition of the magnetic layer 1202. This non-magnetic layer 1302, preferably is a material comprising, Ru, Rh, Os, Ta, Ti, MgO, AlO or a combination thereof, further provides a smooth surface after deposition. When material 1302 is made of Ru, Rh, Os or their alloys, it can provide either ferromagetic or antiferromagnetic exchange coupling to free layer 1102, depending on the thickness of layer 1302, as is well known in the prior art. For most metals or oxides such as Ta, Ti, MgO, or AlO, no direct exchange coupling is provided, so that free layer 1002 and magnetic layer 1302 are antiferromagnetically coupled only through magnetostatic fields generated primarily at the ends of each layer. A weakly coupled multilayer free layer can have a lower critical spin torque current with an increased magnetic volume which is desirable for stability against thermal fluctuations. See for example, U.S. patent application Ser. No. 11/870,856 assigned to the Assignee of the present application.

In an alternative embodiment, the structure in FIG. 13 can be inverted so that layer 1202 in next to spacer layer 1108. In a variation of this embodiment, non-magnetic layer 1302 can also be deposited at an oblique angle with no wafer rotation. Then layer 1302 will have a microstructure that will induce additional magnetic anisotropy in free layer 1102. In another variation of this embodiment, layer 1102 can be deposited in the standard way with wafer rotation, so that any H_{K-oblique} is induced by layer 1302 alone which is deposited at an oblique angle without wafer rotation.

The structure 1400 of FIG. 14 includes two additional layers 1404, 1406 deposited at a non-zero deposition angle from opposed directions to the spacer layer 1108 and over the non-magnetic layer of FIG. 13. Numerous reference numerals shown in FIG. 14 represent like elements from FIG. 13. The layers 1404, 1406 are preferably a material comprising CoFeB. These additional layers 1404, 1406 provide additional high induced anisotropy, hence high H_{K} for the free layer. This structure can also provide synthetic ferromagnetic or anti-ferromagnetic coupling through the non-magnetic layer 1302.

Another structure 1500 (FIG. 15) includes another non-magnetic layer 1502 deposited on the layer 1406 of FIG. 14 prior to the deposition of the magnetic layer 1202. This non-magnetic layer 1502, preferably is a material comprising Ta, Ru, MgO, AlO or a combination thereof, further provides a smooth surface after deposition Referring to FIG. 16, the structure 1600 includes a non-oblique magnetic layer 1602 deposited in the standard way with wafer rotation (an average zero deposition angle to perpendicular to the surface) on the spacer layer 1108 before the layers 1104, 1106 are obliquely deposited. This structure 1600 provides a sharp interface between spacer layer 1108 and non-oblique magnetic layer 1602, and hence a sharp interface (less mixing) between the free layer and the tunnel barrier, which leads to high breakdown voltage of dielectric tunneling barrier with less partial shorts, and hence improve reliability of devices.

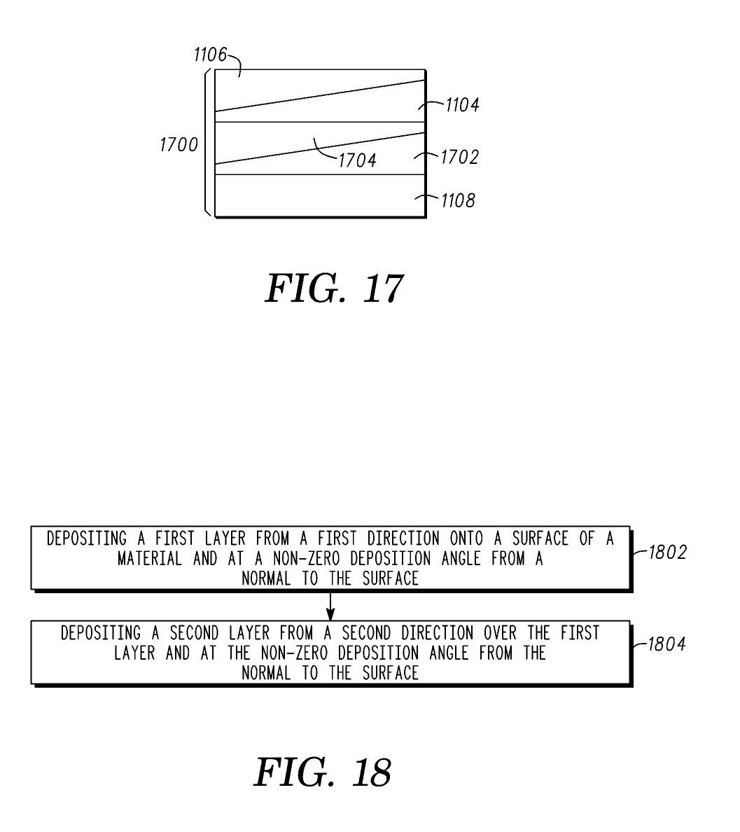

Each of the exemplary embodiments described above having the layers 1104, 1106 and layers 1404, 1406 may include additional layers formed at a non-zero deposition angle from opposed directions and adjacent to the layers 1104, 1106, 1404, 1406. See for example the free layer 1700 of FIG. 17 having layers 1702, 1704 deposited over the spacer layer 1108 before the layers 1104, 1106 are deposited. The layers 1702, 1704 preferably comprise a material formed of Fe or CoFe and provide the advantages of a high magnetoresistance ratio. Alternatively, spacer layer 1108 may be a bottom electrode material when the tunnel barrier is placed on top of the free layer, in which case layers 1702, 1704 may be non-magnetic seed layers to enhance the microstructural anisotropy of the magnetic layers 1104, 1106.

FIG. 18 is a flow chart that illustrates an exemplary embodiment of fabrication method for the exemplary embodiments described herein. The fabrication method represents one implementation of an exemplary method for forming a free layer of a MRAM. For illustrative purposes, the following description of the method may refer to elements mentioned above in connection with FIGS. 1, 3-7, and 11-17. It should be appreciated that the method may include any number of additional or alternative steps, the steps shown in FIG. 18 need not be performed in the illustrated order, and the method may be incorporated into a more comprehensive method having additional functionality not described in detail herein. Moreover, one or more of the steps shown in FIG. 18 could be omitted from an embodiment of the method as long as the intended overall functionality remains intact.

Referring to FIG. 18, a first layer is deposited 1802 from a first direction onto a surface of a material and at a non-zero deposition angle from a normal to a surface; and a second layer is deposited 1804 from a second direction over the first layer and at the non-zero deposition angle from the normal to the surface, the first and second directions being opposed.

In summary, a thin film magnetic device includes a nonmagnetic spacer layer formed between a magnetic layer and a free layer. The free layer includes a first ferromagnetic region positioned over the first surface and having a second surface opposed to the spacer layer, the second surface forming a plane at an angle with the first surface; and a second ferromagnetic region positioned on the first magnetic region and having a third surface opposed to the first magnetic region, the third surface parallel with the first surface, the first and second ferromagnetic regions having a deposition-induced microstructural magnetic anisotropy easy axis with an anisotropy field H_{k-oblique} greater than 50 Oe and preferably greater than 100 Oe. The free layer is patterned into a shape with sub-micron dimensions and has an energy barrier to thermal reversal greater than 50 kT, at the operating temperature T, due to a significant contribution to thermal stability from the high microstructural magnetic anisotropy. One or more optional layers may be in contact with the first and second magnetic regions to reduce roughness or improve resistance to diffusion from adjacent layers.

Thus, a new and improved method of depositing a material layer for magnetoelectronic devices, such as MRAM devices including MTJ and/or GMR devices, magnetic sensors, etc., which utilize a ferromagnetic layer has been disclosed. The method involves two or more adjacent layers of a free layer, each deposited from opposite directions at a nonzero deposition angle. An advantage of this deposition method is that the induced magnetic anisotropy is substantially more stable with temperature than anisotropy from pair ordering. Another advantage is a large range of values for the magnitude of the induced anisotropy can be obtained and controlled by setting the deposition angle. The larger anisotropies in the range can be used to significantly increase the total anisotropy of the device, enabling a high energy barrier to thermal reversal with reduced magnetic moment, resulting in reduced critical current for spin-torque switching in thermally stable devices. Still another advantage is that the new and improved deposition method produces a well-defined anisotropy axis without need for an applied magnetic field during deposition. Although it will be understood that an applied magnetic field can be used if desired. Further, the nonzero deposition angle can be chosen to supplement or oppose the shape anisotropy or the pair ordering anisotropy. Also, a sufficiently large induced anisotropy can be used in creating a fixed layer, if desired, so that an antiferromagnetic pinning layer may not be required.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method of fabricating a monolithically integrated device, comprising:
depositing a first layer from a first direction onto a surface of a material and at a first non-zero deposition angle from a normal to the surface; and
depositing a second layer from a second direction over the first layer and at a second non-zero deposition angle from the normal to the surface.

2. The method of claim 1, wherein the first and second layers are ferromagnetic.

3. The method of claim 1, wherein the first and second directions are opposed with respect to the surface, and the first and second non-zero deposition angles are equal.

4. The method of claim 1, further comprising depositing a third layer over the second layer from a range of directions resulting in an average zero deposition angle from the normal to the surface.

5. The method of claim 4, wherein the first, second, and third layers are ferromagnetic, further comprising forming a first non-magnetic layer between the second layer and the third layer.

6. The method of claim 5, wherein the first non-magnetic layer comprises a second surface opposed to the second magnetic layer, the method further comprising:
depositing a fourth magnetic layer on the second surface of the non-magnetic layer from the first direction and at the first non-zero deposition angle from a normal to the surface and having a third surface opposed to the non-magnetic layer; and
depositing a fifth magnetic layer on the third surface of the fourth magnetic layer from the second direction and at the second non-zero deposition angle from a normal to the surface, the fourth and fifth magnetic layers having an induced microstructural magnetic anisotropy with a magnitude and a direction from the non-zero deposition angle.

7. The method of claim 6, further comprising forming a second non-magnetic layer between the third and fifth ferromagnetic layers.

8. The method of claim 2, further comprising forming a third layer between the surface and the first layer from a range of directions resulting in an average zero deposition angle from the normal to the surface, the third layer being ferromagnetic.

9. The method of claim 8, further comprising forming a non-magnetic layer between the first and third layers.

10. The method of claim 1, wherein the first and second layers comprise first and second ferromagnetic layers, respectively, further comprising:
depositing a first non-magnetic layer on the second ferromagnetic layer;
depositing a third ferromagnetic layer from the first direction onto the first non-magnetic layer and at the first non-zero deposition angle from a normal to the surface; and
depositing a fourth ferromagnetic layer from the second direction onto the third ferromagnetic layer and at the second non-zero deposition angle from a normal to the surface.

11. The method of claim 1, wherein the first and second layers comprise first and second ferromagnetic layers, respectively, further comprising:
depositing a third ferromagnetic layer from the first direction onto the second ferromagnetic layer and at the first non-zero deposition angle from a normal to the surface; and
depositing a fourth magnetic layer from the second direction onto the third ferromagnetic layer and at the fourth non-zero deposition angle from a normal to the surface;
wherein the first and second ferromagnetic layers are the same material, and the third and fourth ferromagnetic layers are the same ferromagnetic material.

12. The method of claim 11, wherein the first and second layers comprise Fe.

13. The method of claim 11, wherein the first and second layers are nonmagnetic.

14. The method of claim 2, wherein the deposition direction of the first and second layers induces a microstructural anisotropy field H_{K-oblique} greater than 50 Oe.

15. The method of claim 1 wherein the first and second layers comprise first and second magnetic layers, respectively, further comprising:
providing a substrate;
depositing a third magnetic layer on the substrate prior to providing the insulating material,
wherein the third magnetic layer comprises a pinned region, the insulating material comprises a tunnel barrier, and the first and second magnetic layer comprise a free region.

16. A method of fabricating a monolithically integrated device, comprising:
providing a substrate;
providing an insulating material having a surface forming a plane;
depositing a first magnetic layer over the surface from a direction and at a non-zero angle from the normal to the surface;
rotating by 180 degrees the substrate and the first magnetic layer deposited thereon; and
depositing a second magnetic layer onto the first magnetic layer from the same direction and at the non-zero angle from the normal to the surface.

17. The method of claim 16 further comprising:
depositing a third magnetic layer on the substrate prior to providing the insulating material,
wherein the third magnetic layer comprises a pinned region, the insulating material comprises a tunnel barrier, and the first and second magnetic layer comprise a free region.

18. The method of claim 16, wherein the first and the second ferromagnetic layers comprise at least one selected from a group consisting of CoFeB, NiFe, Fe, CoFe, NiFeCo, NiFeX and CoFeX, wherein X is a non-magnetic material.

19. The method of claim 16, wherein the oblique deposition of the first and second magnetic layers induces a microstructural anisotropy field H_{K-oblique} greater than 50 Oe.

20. A method of fabricating a monolithically integrated device, comprising:
providing an insulating material having a surface forming a plane;
depositing a first ferromagnetic layer onto the surface from a first direction and at a non-zero angle from the normal to the surface; and
depositing a second ferromagnetic layer onto the first magnetic layer from a second direction and at the same angle from the normal to the surface, the second direction being opposed to the first direction.
